(19) United States
(12) Patent Application Publication
(10) Pub. No.: US 2021/0138879 A1
(43) Pub. Date: May 13, 2021

(54) UV PROTECTION SCREEN FOR VEHICLES

(71) Applicant: MOCKSTAR, INC., Toledo, OH (US)

(72) Inventor: Rose M. Mock, Toledo, OH (US)

(21) Appl. No.: 17/093,031

(22) Filed: Nov. 9, 2020

Related U.S. Application Data
(60) Provisional application No. 62/932,637, filed on Nov. 8, 2019.

(51) Int. Cl. B60J 1/20

(52) U.S. Cl. CPC B60J 1/2041; B60J 1/2086; B60J 1/2063; B60J 1/2047

(57) ABSTRACT

A UV protection screen for a vehicle window includes a screen element having a UV blocking material. The UV blocking material is substantially clear and is configured to block at least 70% of UV light passing through the screen element. The UV blocking material is formed from a ceramic including titanium dioxide and neodymium oxide. The UV protection screen further includes a mounting device configured to couple the screen element to the vehicle window.

### CROSS-REFERENCE TO RELATED APPLICATION

This patent application claims priority to U.S. Provisional Patent Application Ser. No. 62/932,637, filed on Nov. 8, 2019, the entire disclosure of which is hereby incorporated herein by reference.

### FIELD

The present technology relates to sunlight protection screens, and more particularly, to an ultraviolet (UV) light protection screen for a vehicle window, including wherein the UV protection screen is formed of a substantially clear material allowing viewing therethrough and wherein the screen is designed to protect against the harmful effects of heat and radiation from the sun.

### INTRODUCTION

This section provides background information related to the present disclosure which is not necessarily prior art.

Window screens or shades can be placed in vehicle windows to reduce the effect of heat and radiation from the sun on one or more occupants within the vehicle. This is particularly true when children are present in the vehicle, as children can be confined to a car seat and may be unable to move to escape direct sunlight shining through a vehicle window. Such window screens or shades can take the form of a piece of material, such as a flexible fabric or plastic, attached to one or more suction cups, wherein the suction cups are held onto a window surface via a vacuum created between the suction cup and the smooth, nonporous surface of the vehicle window. Often the window shade material is tinted, dark, and/or formed of a perforated opaque material to block a portion of incoming sunlight. The degree of darkness or shading, up to and including opaqueness, of the material is typically proportional to its effectiveness in blocking sunlight, including the UV component of sunlight. However, dark or shaded materials can obstruct the view of a passenger as well as the view of an operator of the vehicle. Substantially opaque materials can restrict any view in or out of the vehicle window. Local laws or regulations can prohibit the placement of devices that obstruct the view of the vehicle operator and/or obstruct the view into the vehicle from the outside during operation of the vehicle.

It is desirable to improve materials for such window screens or shades, including improvements in UV protection to minimize fading and cracking of interior materials and minimize exposure of vehicle passengers to UV radiation responsible for burnt skin and skin cancer. It is further desirable to provide materials for such vehicle window shades that minimize the obstruction of visible light, and hence the view into or out from the vehicle, while maintaining an effective reduction of UV light impacting the interior and occupants of the vehicle.

### SUMMARY

The present technology includes articles of manufacture, systems, and processes that relate to UV protection screens that can be positioned on a window of a vehicle to minimize exposure of occupants and the vehicle interior from harmful effects of the ultraviolet component of sunlight.

UV protection screens for a vehicle window are provided that include a UV blocking material and a mounting device. The UV blocking material is provided in the form of a screen element configured to block at least about 70% of UV light passing therethrough. The screen element may be formed as a substantially planar and substantially clear film or sheet comprising the UV blocking material. The mounting device is configured to couple the screen element comprising the UV blocking material to the vehicle window. The screen element comprising the UV blocking material can be provided to include a substantially polygonal perimeter shape, such as a square shape, a rectangular shape, a trapezoidal shape, a triangular shape, or any other polygonal shape corresponding to the shape and configuration of a corresponding glass pane or window, such as one or more windows of a corresponding vehicle. The screen element may be formed from a single layer of the UV blocking material or a combination of the UV blocking material and at least one additional layer, such as a base layer engaging the UV blocking material or a combination of multiple layers with at least one of the layers comprising the UV blocking material. The UV blocking material can include a ceramic configured to block the UV light passing through the UV blocking material. The UV protection screen can further include a roller, where the screen element comprising the UV blocking material is retractable onto the roller. The mounting device can include at least one suction cup for coupling the screen element to the corresponding window. Methods of using such UV protection screens are also provided, such as coupling such UV protection screens to the window of the vehicle.

In an embodiment of the present invention, a UV protection screen for a vehicle window comprises a screen element comprising a UV blocking material. The UV blocking material is substantially clear and is configured to block at least 70% of UV light passing through the screen element. The UV protection screen further comprises a mounting device configured to couple the screen element to the vehicle window.

A method of blocking UV radiation entering a vehicle is also disclosed. The method comprises the steps of: providing a UV protection screen comprising a screen element and a mounting device, the screen element comprising a UV blocking material, the UV blocking material being substantially clear and configured to block at least 70% of UV light passing through the screen element; and removably mounting the screen element to a window of the vehicle using the mounting device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of a first embodiment of a UV protection screen constructed in accordance with the present technology attached to a window of a vehicle door.

FIG. 2 is an illustration of a second embodiment of a UV protection screen constructed in accordance with the present technology attached to a window of a vehicle door.

FIG. 3 is an illustration of a suction cup useful for coupling material used in a UV protection screen constructed in accordance with the present technology to a vehicle window.

FIG. 4 is a perspective view of a third embodiment of a UV protection screen constructed in accordance with the present technology.

FIG. 5 is an illustration of a fourth embodiment of a UV protection screen constructed in accordance with the present technology, wherein the UV protection screen is dimensioned for a relatively large vehicle window such as would be present in a sport utility vehicle.

FIG. 6 is an illustration of a fifth embodiment of a UV protection screen constructed in accordance with the present technology, wherein the UV protection screen is dimensioned for a relatively small vehicle window such as would be present in a sedan.

FIG. 7 is an in-use view of the fourth embodiment of the UV protection screen of FIG. 5 when installed in an exemplary sport utility vehicle.

FIG. 8 is an in-use view of the fifth embodiment of the UV protection screen of FIG. 6 when installed in an exemplary sedan.

FIG. 9 is a cross-sectional view of a single layered screen element of a UV protection screen comprising a UV blocking material.

FIG. 10 is a cross-sectional view of a multi-layered screen element of a UV protection screen comprising a base layer and a UV blocking material.

FIG. 11 is a cross-sectional view of a single layered screen element of a UV protection screen comprising a base layer having a UV blocking material embedded therein.

FIG. 12 is a perspective view of a sixth embodiment of a UV protection screen constructed in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides ways of blocking UV light, including the use of a UV protection screen that can be positioned within a vehicle window to protect the interior and one or more occupants of the vehicle from the harmful effects of UV radiation. Each of the disclosed UV protection screens can include a UV blocking material, where the UV blocking material is provided in the form of a substantially planar and substantially clear film or sheet that is configured to block at least about 70% of UV light passing therethrough. The film or sheet comprising the UV blocking material is more generally referred to as a screen element hereinafter. A mounting device can be included that is configured to couple the screen element comprising the UV blocking material to the vehicle window.

The UV blocking material is substantially clear (e.g., see through) and allows most visible light to pass therethrough while blocking at least about 70% of the UV component of light passing therethrough. The UV blocking material may be a ceramic solar UV protection material. In this way, the UV blocking material minimizes interference with visibility into and out of the window of the vehicle. The substantially clear nature of the UV blocking material can prevent an installed use of the UV protection screen from contravening local laws or regulations related to obstructing a view of a vehicle operator and/or obstructing a view into the vehicle from the outside. The substantially clear nature of the UV blocking material prevents the UV protection screen from being classified as window tinting, for example, hence the present invention is distinguishable from such window tinting structures. The ceramic component can act as a heat barrier and UV protectant that can minimize interior fade and possible skin cancer risk or other damage from sunlight as experienced within an interior of the associated vehicle.

The UV protection screen can be pre-cut to fit passenger and/or driver side windows of vehicles and does not require professional installation. For example, the screen element can be coupled to a respective window using one or more coupling devices (e.g., suction cups) to provide UV protection where desired. The screen element can be moved from window to window or removed and put back up anytime, as desired by an occupant of the vehicle. Example sizes include UV protection screens having a screen element that is approximately 20″ wide and 18″ long for larger windows in vehicles such as sport utility vehicles (SUVs). Smaller windows of passenger cars can use screen elements sized approximately 15″ wide and 15″ long. It should be apparent that substantially any dimensions may be selected for the screen element of such a UV protection screen in accordance with the specifications of the corresponding vehicle, including screen elements having smaller dimensions or larger dimensions than those provided as examples hereinabove.

A particular aspect of the UV blocking material is the inclusion of a ceramic forming at least a portion of the UV blocking material, including but not limited to forming an entirety of the corresponding screen element. In certain embodiments, the UV blocking material includes a sensibly colorless transparent glass-ceramic from a glass-ceramic composition containing more than 0.50 weight % titanium dioxide and possibly iron oxide, that would normally provide colored glass-ceramics. The glass-ceramic can be manufactured by a process that includes incorporating into the glass-ceramic composition an appropriate proportion of neodymium oxide so as to make the glass-ceramic sensibly colorless. The resulting colorless glass ceramic allows for the benefits of the UV blocking properties described above to be appreciated while also preventing the formation of any type of visual hazard, excessive tinting, or the like that may contravene local laws or regulations limiting such visual obstructions.

In one example, the glass used has the following composition, in weight percent: SiO₂, 60; TiO₂, 6; Al₂O₃, 24; Fe₂O₃, 0.02; Li₂O, 3.5; P₂O₅, 4. This glass is melted at 1600° C. for 24 hours in a 1 liter silica crucible to avoid any influence that a crucible made of rhodium platinum could have on the tint. Its color is characterized by transmission curve No. 1 of FIG. 1 of U.S. Pat. No. 4,093,468 to Boitel et al. (hereinafter “Boitel”), which is hereby incorporated herein in its entirety. The glass can be designated as very pale yellow at this stage. A sample of this glass is treated for 2 hours at 870° C. to change it into a transparent glass-ceramic containing around 90% crystal phase which is mainly a beta-quartz solid solution. The color of this glass-ceramic is characterized by curve No. 1 of FIG. 2 of Boitel, and generally includes an amber color.

The same base glass composition is melted with the addition of 0.004% of cobalt oxide CoO. The colors before and after ceramming are characterized by curves No. 2 of FIGS. 1 and 2 of Boitel, respectively. Visually the sample appears colourless before ceramming and purple after ceramming. By comparing the curves No. 2 of FIGS. 1 and 2, a strong modification is noticed in the form during ceramming. Although at about 0.65 micron transmission remains unchanged, it decreases by about 10% at about 0.50 micron, which explains the evolution of the tint.

The same base glass composition is melted with the addition of 0.3% of neodymium oxide Nd₂O₃. The colors before and after ceramming are characterized by the curves No. 3 of FIGS. 1 and 2 of Boitel, respectively. Visually the sample seems colorless before and after ceramming. By comparing curves No. 3 of FIGS. 1 and 2, one notices the low modification of the absorption bands of Nd₂O₃ during ceramming contrary to the previous case. The thermal expansion coefficient of this glass-ceramic is less than 15×10−7 /K.

In another example, the proportion of neodymium oxide to be incorporated into the composition of a transparent glass-ceramic so as to obtain a colorless glass-ceramic is determined. According to an operation mode similar to the prior example, one prepares a series of glass-ceramics having the basic compositions A, B, C and D indicated in Table 1, and containing diverse proportions of Fe₂O₃ and Nd₂O₃. The colors obtained before and after ceramming are also indicated in the following table.

TABLE

| Basic Composition | | | Amount Fe₂O₃ | Nd₂O₃ | | Colour Before | Color After |
|---|---|---|---|---|---|---|---|
| Weight % | | | ppm | wt. % | Trial No. | Ceramming | Ceramming |
| | A | | | 0 | 1 | Yellow | Yellow |
| SiO₂ | | 69.4 | | 0.1 | 2 | Pale Yellow | Yellow |
| Al₂O₃ | | 18.7 | | | | | |
| Li₂O | | 3.5 | | 0.2 | 3 | Colourless | Colourless |
| MgO | | 1.8 | 140 | | | | |
| BaO | | — | | 0.3 | 4 | Very pale violet | Very pale Violet |
| | | | | | | to pink | to very pale Pink |
| ZnO | | 0.8 | | | | | |
| TiO₂ | | 3.0 | | 1.0 | 5 | Pale violet | Pale violet |
| ZrO₂ | | 2.0 | | 0 | 6 | Yellow | Dark yellow |
| P₂O₅ | | — | | 0.2 | 7 | Yellow | Yellow |
| As₂O₃ | | 0.8 | | 0.3 | 8 | Very pale yellow | Very pale yellow |
| | | | 380 | 0.4 | 9 | Colourless to very | Colorless to very |
| | | | | | | pale pink | pale pink |
| | | | | 1.0 | 10 | Pale violet | Pale violet |
| | B | | | | | | |
| SiO₂ | | 62.0 | | 0 | 11 | Pale Yellow | Yellow |
| Al₂O₃ | | 21.3 | | 0.05 | 12 | Pale yellow | Yellow |
| Li₂O | | 2.7 | | | | | |
| MgO | | 1.0 | 100 | 0.1 | 13 | Very pale yellow | Very pale yellow |
| BaO | | 1.3 | | 0.15 | 14 | Colourless | Colourless |
| CaO | | 0.5 | | | | | |
| ZnO | | 6.0 | | 0.30 | 15 | Pale violet | Pale violet |
| TiO₂ | | 1.8 | | | | | |
| ZrO₂ | | 2.0 | | 0 | 16 | Yellow | Darker yellow |
| P₂O₅ | | 0.7 | | 0.15 | 17 | Pale yellow | Yellow |
| As₂O₃ | | 0.7 | 350 | 0.2 | 18 | Very pale yellow | Pale yellow |
| | | | | 0.25 | 19 | Colourless | Colourless |
| | | | | 0.40 | 20 | Pale violet | Pale violet |
| | C | | | | | | |
| SiO₂ | | 61.0 | 160 | 0 | 21 | Yellow | Yellow |
| Al₂O₃ | | 23.0 | | 0.35 | 22 | Colourless | Very pale yellow |
| | | | | | | | to colourless |
| Li₂O | | 3.5 | | | | | |
| MgO | | 0.1 | | 0.5 | 23 | Pale violet | Pale violet |
| ZnO | | 0.3 | | | | | |
| TiO₂ | | 6.0 | | | | | |
| ZrO₂ | | 1.5 | | | | | |
| P₂O₅ | | 4.0 | | | | | |
| As₂O₃ | | 0.6 | | | | | |
| | D | | | 0 | 24 | Pale yellow | Yellow |
| SiO₂ | | 61.2 | | | | | |
| Al₂O₃ | | 24.0 | 160 | 0.25 | 25 | Colourless | Colourless |
| Li₂O | | 3.4 | | | | | |
| MgO | | — | | 0.35 | 26 | Pale violet | Pale violet |
| ZnO | | 0.5 | | 0.25 | 27 | Pale yellow | Pale yellow |
| TiO₂ | | 4.0 | | | | | |
| ZrO₂ | | 2.0 | 440 | 0.35 | 28 | Colourless | Colourless to very |
| | | | | | | | pale violet |
| P₂O₅ | | 4.2 | | | | | |
| As₂O₃ | | 0.7 | | 0.50 | 29 | Pale violet | Pale violet |

According to the above provided table, it is apparent that glass-ceramics having the basic composition A at 3% TiO₂ can be decolorized by the incorporation of Nd₂O₃ at 0.20% when they contain 140 ppm Fe₂O₃ (trial No. 3) and by the incorporation of about 0.35% Nd₂O₃ when they contain 380 ppm Fe₂O₃ (as determined by interpolation between trials No. 8 and 9).

Glass-ceramics having the composition B at 1.8% TiO₂ can be decolorized by the incorporation of 0.15% Nd₂O₃ when they contain 100 ppm Fe₂O₃ (trial No. 14) and by an incorporation of 0.25% Nd₂O₃ when they contain 350 ppm Fe₂O₃ (trial No. 19). Glass-ceramics having the basic composition C with 6% TiO₂ and a rather high amount of P₂O₅ can be decolorized by the incorporation of about 0.40% Nd₂O₃ when they contain 160 ppm Fe₂O₃ (as determined by interpolation between trials No. 22 and No. 23). Glass-ceramics having the basic composition D with 4.0% TiO₂ and a rather high amount of P₂O₅ can be decolorized by the incorporation of 0.25% Nd₂O₃ when they contain 160 ppm Fe₂O₃ (trial No. 25) and by the incorporation of 0.32% Nd₂O₃ when they contain 440 ppm Fe₂O₃ (as determined by interpolation between trials No. 27 and No. 28).

As we can see according to the above results, the proportion of neodymium oxide to be incorporated in the basic composition to obtain a colorless transparent glass-ceramic varies with the amount of titanium dioxide and with the amount of ferric oxide (present as impurities in raw materials or refractories used in manufacturing equipment) and with the base composition of the glass-ceramic. It is practically impossible, therefore, to forecast what proportion of Nd₂O₃ will have to be added to a glass-ceramic composition to obtain a colorless glass-ceramic. It will be generally necessary therefore, to prepare a series of compositions with increasing additions of Nd₂O₃ to be able to determine, either directly from the results obtained, or by interpolation, the appropriate amount of neodymium oxide to be incorporated to get the desired decolorizing effect.

The decolorizing effect can be obtained with compositions of glass-ceramics different from those specifically described in the above examples and the present technology is not limited to those particular compositions. Further details of the UV blocking material including a sensibly colorless transparent glass-ceramic composition are provided in the disclosure of Boitel.

The UV protection screen can further include a roller where the screen element comprising the UV blocking material is retractable onto the roller. Likewise, the mounting device can include at least one suction cup for mounting the roller and/or the screen element comprising the UV blocking material directly to the corresponding window. The UV protection screen may alternatively include a border or layer configured to electrostatically mount the screen element thereof to the corresponding window in the absence of the at least one suction cup.

The UV protection screen can be used in various ways to minimize UV exposure through various windows, including the use such UV protection screens on multiple windows and the use of more than one UV protection screen on the same window.

With reference now to the figures, several embodiments of the present technology are shown and described as follows.

FIG. 1 is an illustration of a vehicle door 100 having a UV protection screen 101 attached to the vehicle window 104. As shown in FIG. 1, the UV protection screen 101 typically includes a screen element of substantially clear UV blocking material formed into a suitable perimeter shape, such as a rectangle, and attached to a plurality of suction cups 102.

As used herein, the term “screen element” refers to a structure having opposing exposed surfaces having surface areas that are many times greater than a thickness of the structure, thereby forming the sheet-like or film-like configuration of each of the disclosed screen elements. Each of the disclosed screen elements is provided to be flexible in a manner allowing for each of the screen elements to conform to the shape of the corresponding window without having to undergo plastic deformation. For example, any slight curvature present within the corresponding surface of the window to which the screen element is coupled may be accounted for by the flexibility of the screen element to prevent the formation of undesirably large gaps between the corresponding surface of the window and the surface of the screen element facing towards the window when the screen element is drawn substantially taught relative to the window. The flexibility of the screen element also facilitates the ability to roll the screen element to allow for compactness of the UV protection screen when not in use.

In use, each suction cup 102 is pressed onto the surface of the window 104, thus fixing the UV protection screen 101 into place on the interior surface of the vehicle window 104. The suction cups 102 may be pulled away from one another to cause the corresponding screen element to be drawn taught while disposed substantially parallel to the corresponding surface of the window 104. Once the UV protection screen 101 is fixed in place, the UV protection screen 101 provides protection from the ultraviolet component of sunlight for individuals sitting near the vehicle window 104. In addition to temporarily attaching the UV protection screen 101 to the vehicle window 104, the suction cups 102 further allow the UV protection screen 101 to be moved around the interior window surface to adjust for vehicle movement relative to incoming sunlight without harming the interior surface of the window 104. The use of the suctions cups 102 facilitates a non-professional installation of the UV protection screen 101 to the window 104, which is in contrast to traditional window tinting structures that require professional installation.

FIG. 2 is an illustration of a vehicle door 100 having a retractable UV protection screen 200 attached to the vehicle window 104. The retractable UV protection screen 200 of FIG. 2 typically includes a screen element comprising the substantially clear UV blocking material rolled onto a roller 202, which is attached to a plurality of suction cups 102. Specifically, an outermost end portion of the screen element is coupled to the roller 202 in a manner wherein rotation of a corresponding portion of the roller 202 causes the screen element to roll onto or unroll from a cylindrical surface of the roller 202.

In use, the suction cups 102 are pressed onto the surface of the vehicle window 104, thus fixing the roller 202 of the retractable UV protection screen 200 into place on the interior surface of the vehicle window 104. Once the roller 202 is fixed in place on the vehicle window 104, a pull cord 204 can be used to unroll a section of the screen element of the substantially clear UV blocking material from the roller 202 to provide protection from the ultraviolet component of sunlight for the interior of the vehicle. The unrolled section of the screen element can then be attached to the surface of the vehicle window 104 using a further suction cup 102, thus holding the unrolled section of the screen element in place and temporarily preventing it from rolling back up onto the roller 202 of the retractable UV protection screen 200. Thereafter, the retractable UV protection screen 200 provides protection from incoming sunlight for individuals sitting near to the vehicle window 104. Similar to the UV protection screen described with respect to FIG. 1, the suction cups 102 allow the retractable UV protection screen 200 to be moved about the interior window surface to adjust for vehicle movement relative to incoming sunlight without harming the interior surface of the window 104.

FIG. 3 is an illustration of a suction cup 102 useful for coupling material used in a UV protection screen to a vehicle window. The suction cup 102 can be provided with an adaptor 103 configured to mount the suction cup 102 to the screen element of the UV blocking material, such as the metal hook shown, or can have an integrally molded feature (not shown) configured to couple with the UV protection screen, a roller of the UV protection screen, a corner of the UV protection screen, and/or a tab located on the substantially clear UV blocking material of the UV protection screen.

FIG. 4 is an illustration of a retractable UV protection screen 10 including a screen element 12 comprising the clear UV blocking material rolled onto a roller 14. The roller 14 is attached to a pair of suction cups 16 adjacent opposing ends of the roller 14 with respect to an axial direction thereof. The roller 14 may include an outer shell 15 provided as a hollow cylinder rotatably supporting a rotatable shaft 17 about which the screen element 12 rolls when retracted or extended from the roller 14. The outer shell 15 may include an axially extending opening 19 formed therein through one side thereof, wherein the screen element is fed through the axially extending opening 19 when rolled onto or off of the rotatable shaft 17. A pair of the suction cups 16 is coupled to the outer shell 15 of the roller 14 with each of the suctions cups 16 disposed towards opposing axial ends of the outer shell 15.

The screen element 12 includes an end strip 11 formed opposite a portion of the screen element 12 coupled to the rotatable shaft 17. The end strip 11 accordingly forms a distal portion of the screen element 12 when the screen element 12 is fully extended away from the roller 14. A pair of the suction cups 16 is coupled to the end strip 11 with each of the suction cups 16 disposed adjacent opposing ends of the end strip 11 with respect to the axial direction of the roller 14. A tab 13 extends perpendicularly from the end strip 11 and forms a pull cord for extending the screen element 12 away from the roller 14. The end strip 11 and the tab 13 may be formed from a different material than the UV blocking material, as desired.

The roller 14 may include a spring loaded mechanism (not shown) configured to selectively retract the screen element 12 back into the roller 14 upon a user initiated action. The spring loaded mechanism may be configured to operate similarly to retractable window blinds wherein a pull and release of the tab 13 causes a torsion spring of the spring loaded mechanism to urge the screen element 12 to roll back onto the rotatable shaft 17. A pulling of the tab 13 is in turn configured to overcome the urging of the torsion spring to cause the extension of the screen element 12 away from the roller 14 to reach the fully extended configuration shown in FIG. 4.

FIGS. 5 and 7 illustrate a UV protection screen 18 that may be particularly well suited for use with a vehicle such as an SUV 24 having relatively large windows. As mentioned previously, such a UV protection screen 18 may include a screen element comprising the UV blocking material that is approximately 20″ wide and 18″ long, as a non-limiting example, to accommodate the larger windows of the SUV 24.

FIGS. 6 and 8 illustrate a UV protection screen 20 that may be particularly well suited for use with a vehicle such as an sedan 22 having relatively small windows in comparison to the previously disclosed SUV 24. As mentioned previously, such a UV protection screen 20 may include a screen element comprising the UV blocking material that is approximately 15″ wide and 15″ long, as a non-limiting example, to accommodate the windows of the sedan 22.

FIG. 9 illustrates one possible configuration of a screen element 400 formed from the UV blocking material, wherein the screen element 400 may be used with respect to any of the disclosed UV protection screens 10, 18, 20, 101, 202. The UV blocking material may be any of the glass ceramic compositions described as being substantially colorless while having the desired UV blocking properties, such as those materials indicated as being colorless in the provided table or any variations thereof. Although the screen element 400 is shown as being comprised of a single layer of the UV blocking material in FIG. 9, it should be understood that a laminate of multiple different layers all comprised of the UV blocking material may also be utilized without departing from the scope of the present invention, as desired.

FIG. 10 illustrates one possible configuration of a screen element 500 formed from a base layer 505 and a UV blocking layer 510. The screen element 500 may be used with respect to any of the disclosed UV protection screens 10, 18, 20, 101, 202. The base layer 505 may be configured to face towards and engage the corresponding surface of the vehicle window. The base layer 505 may be provided as a polymeric material. More specifically, the base layer 505 may be an organic based material formed to be substantially clear and colorless, such as a polyester, polyethylene terephthalate, polypropylene, polycarbonate, polyimide, polyamide, nylon, polyvinyl chloride, or combinations of such organic based materials, including blends or multilayer laminates of any of the listed organic based materials. The UV blocking layer 510 is coupled to or otherwise laminated to the base layer 505 and is formed from any of the disclosed UV blocking materials or variations thereof in similar fashion to the screen element 400.

FIG. 11 illustrates yet another possible configuration of a screen element 600 formed from a base layer 605 having a plurality of inserts 610 of a UV blocking material disposed or embedded therein. The screen element 600 may be used with respect to any of the disclosed UV protection screens 10, 18, 20, 101, 202. The base layer 605 may be formed from a suitable polymeric material that is substantially clear and capable of being manufactured in a manner for creating an arrangement of the inserts 610 therein, such as a suitable thermoplastic material. For example, the base layer 605 may be formed from any of the organic based materials described hereinabove as being suitable for forming the base layer 505 of the screen element 500. The base layer 605 may be formed from a moldable polymeric material to arrive at the desired shape and configuration of the base layer 605 while also allowing for the introduction of the inserts 610 therein. Although not disclosed, the base layer 605 may also be formed to include a plurality of voids formed therein in addition to the plurality of the inserts 610, as desired, for altering the light transmittance characteristics of the screen element 600.

The inserts 610 of the UV blocking material may be formed from any of the disclosed glass ceramic materials described as being suitable for forming the screen element 400 or any variations thereof. The inserts 610 may have substantially any size and shape, such as being provided as particulates, fibers, strands, or the like, of one or more of the UV blocking materials suitable for providing the characteristics of the present invention. A density and/or configuration of the inserts 610 within the base layer 605 may be selected to impart the desired degree of UV protection to the screen element 600 while maintaining a desired flexibility and transparency thereof.

The base layer 605 may alternatively be referred to as the binding layer of the screen element 600 due to the manner in which the base layer 605 binds the inserts 610 into a desired configuration or pattern during a manufacturing process for forming the screen element 600. The screen element 600 may be formed by the process disclosed in U.S. Pat. No. 6,958,860 to Dontula et al. (hereinafter “Dontula”), wherein the base layer 605 is considered analogous to the disclosed polymeric binder of Dontula while the plurality of the inserts 610 is considered analogous to the disclosed particulates of Dontula. The base layer 605 may also be formed from any of the materials listed by Dontula as being suitable for forming the analogous polymeric binder thereof in addition to those organic based materials listed herein with respect to the base layers 505, 605. A thickness of the base layer 605, a density of the inserts 610 within the base layer 605, and the sizes and configurations of the inserts 610 within the base layer 605 may also be provided within any of the ranges described with regards to the polymeric binder and the embedded particulates of Dontula.

The screen elements considered suitable for use with the present technology are also not limited to those examples provided in FIGS. 9-11. For example, any combination of the different layers 400, 505, 510, 605 may be utilized to result in a screen element having the desired properties including the desired light transmittance, blocking of UV radiation, flexibility, and durability for forming the corresponding screen element. For example, one or more of the base (binding) layers 605 having the inserts 610 therein may be coupled to or sandwiched between one or more of the base layers 505 to create a laminated film wherein some layers are formed in the absence of the UV blocking material while other layers are provided with the desired amount of the UV blocking material. Such a combination of multiple layers may be utilized to provide the corresponding screen element with a desired thickness to both provide the necessary durability of the screen element (including a resistance to tearing or puncturing) by means of increasing the thickness of the laminated screen element. The different layers may also be presented to include variable thicknesses from one another, as desired.

FIG. 12 illustrates a UV protection screen 700 according to another embodiment of the present invention. The UV protection screen 700 differs from the previously disclosed screens by utilizing a mounting portion 705 as the mounting device thereof, in contrast to the previously disclosed suction cup assemblies. The mounting portion 705 is shown as circumscribing a perimeter of a UV blocking portion 710 of the UV protection screen 700.

The mounting portion 705 may be formed from a different material than the UV blocking portion 710. Specifically, the mounting portion 705 may be provided devoid of any UV blocking material, and may instead be formed from a polymeric material that is configured to electrostatically cling to a corresponding surface of the glass of the vehicle window while remaining transparent so as to prevent a visual obstruction through the vehicle window. The polymeric material may be any of the organic based materials described as suitable for forming the base layer 505 of the screen element 500, such as nylon. However, any material capable of forming the desired electrostatic forces for removably mounting the UV protection screen 700 to the glass of the vehicle window may be utilized without necessarily departing from the scope of the present invention.

The mounting portion 705 may be provided as a single layer of the corresponding electrostatically attractive material that surrounds a single layer of the material forming the UV blocking portion 710, thereby reducing the material necessary for forming the mounting portion 705. In other embodiments, the mounting portion 705 may only be disposed along opposing edges of whatever polygonal perimeter shape forms the UV blocking portion 710, or only at the corners formed between adjacent edges of the polygonal perimeter shape of the UV blocking portion 710, so long as the UV protection screen 700 is able to be removably mounted to the corresponding vehicle window in the desired manner.

The screen elements 500, 600 of FIGS. 10 and 11 may also be adapted for electrostatic mounting in similar fashion to that described regarding the mounting portion 705 of the UV protection screen 700. A UV protection screen utilizing one of the screen elements 500, 600 may accordingly be provided in the absence of any type of additional mounting devices such as suction cups or the like. The base layer 505, 605 of each of the screen elements 500, 600 may accordingly be selected to include the desired electrostatic properties to allow for an entirety of the facing surface of each of the respective screen elements 500, 600 to act as a mounting portion capable of clinging to the facing surface of the vehicle window, thereby increasing the attractive forces between each of the screen elements 500, 600 and the vehicle window. As mentioned above, a combination of multiple different layers 505, 510, 605 such as those shown and described in FIGS. 9-11 may also be utilized to accomplish this configuration, such as adding one of the base layers 505 to either or both sides of one of the binding layers 605 or one of the layers 400 formed exclusively from the UV blocking material to allow for the exposed surfaces of the resulting screen element to cling to the vehicle window as described.

The use of an electrostatically attractive layer or border beneficially removes the need for additional mounting structures while also providing the benefit of reducing the profile of the corresponding UV protection screen. Specifically, the total thickness of the UV protection screen can be reduced to an extent wherein the UV protection screen does not interfere with operation of the vehicle window, such as during instances when the vehicle window is being opened or closed. The thin construction of the UV protection screen allows for the UV protection screen to move in unison with the window when moving into or out of a retracted position.

The UV protection screens disclosed herein provide numerous advantages over the window tinting films or the like of the prior art. In contrast to such window tinting films, the disclosed UV protection screens do not require professional installation, which can be costly and time consuming. The mounting of each of the disclosed UV protection screens can be accomplished using only manual manipulation and does not require any type of heat treatment, adhesive, or other additional bonding processes or steps. The removable mounting of each of the disclosed UV protection screens to the windows of the vehicle allows for the UV protection to be customized to the current light conditions and seating arrangements within the vehicle.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A UV protection screen for a vehicle window comprising:
a screen element comprising a UV blocking material, the UV blocking material being substantially clear and configured to block at least 70% of UV light passing through the screen element; and
a mounting device, the mounting device configured to couple the screen element to the vehicle window.

2. The UV protection screen of claim 1, wherein the screen element is substantially planar and includes a polygonal perimeter shape.

3. The UV protection screen of claim 2, wherein the screen element includes a rectangular perimeter shape.

4. The UV protection screen of claim 2, wherein the screen element is configured to be wound into a rolled configuration.

5. The UV protection screen of claim 1, wherein the UV blocking material includes a ceramic.

6. The UV protection screen of claim 5, wherein the ceramic comprises titanium dioxide and neodymium oxide.

7. protection screen of claim 6, wherein the ceramic comprises at least 0.50% by weight of the titanium dioxide.

8. The UV protection screen of claim 6, wherein the ceramic comprises 3.0% by weight of the titanium dioxide and one of 0.20% by weight of the neodymium oxide and 140 ppm of ferric oxide or 0.35% by weight of the neodymium oxide and 380 ppm of ferric oxide.

9. The UV protection screen of claim 6, wherein the ceramic comprises 1.8% by weight of the titanium dioxide and one of 0.15% by weight of the neodymium oxide and 100 ppm of ferric oxide or 0.25% by weight of the neodymium oxide and 350 ppm of ferric oxide.

10. The UV protection screen of claim 6, wherein the ceramic comprises 6.0% by weight of the titanium dioxide and 0.40% by weight of the neodymium oxide and 160 ppm of ferric oxide.

11. The UV protection screen of claim 6, wherein the ceramic comprises 4.0% by weight of the titanium dioxide and one of 0.25% by weight of the neodymium oxide and 160 ppm of ferric oxide or 0.32% by weight of the neodymium oxide and 440 ppm of ferric oxide.

12. The UV protection screen of claim 1, further comprising a roller coupled to the mounting device, wherein the UV blocking material is retractable within the roller.

13. The UV protection screen of claim 1, wherein the mounting device includes at least one suction cup.

14. The UV protection screen of claim 1, wherein the mounting device is a portion of the screen element formed from an electrostatically attractive polymer.

15. The UV protection screen of claim 14, wherein the electrostatically attractive polymer is disposed at a perimeter of the UV blocking material.

16. The UV protection screen of claim 1, wherein the UV blocking material is embedded within a polymeric layer of the screen element.

17. A method of blocking UV radiation entering a vehicle comprising the steps of:
providing a UV protection screen comprising a screen element and a mounting device, the screen element comprising a UV blocking material, the UV blocking material being substantially clear and configured to block at least 70% of UV light passing through the screen element; and
removably mounting the screen element to a window of the vehicle using the mounting device.

18. The method of claim 17, wherein the mounting device includes at least one suction cup.

19. The method of claim 17, wherein the mounting device includes at least one portion of the screen element formed from an electrostatically attractive polymer.
